(19) United States
(12) Patent Application Publication
(10) Pub. No.: US 2019/0015281 A1
(43) Pub. Date: Jan. 17, 2019

(54) PORTABLE SPINAL MANIPULATION TABLE

(71) Applicant: BENJAMIN KARPUS, Atlanta, GA (US)

(72) Inventor: BENJAMIN KARPUS, Atlanta, GA (US)

(21) Appl. No.: 16/036,928

(22) Filed: Jul. 16, 2018

Related U.S. Application Data
(60) Provisional application No. 62/532,535, filed on Jul. 14, 2017.

(51) Int. Cl. A61G 13/10; A61G 13/00; A61G 13/12

(52) U.S. Cl. CPC A61G 13/105; A61G 13/02; A61G 13/121; A61G 13/009

(57) ABSTRACT

Disclosed herein are portable spinal manipulation tables, devices and methods for using same. In one aspect, the portable spinal manipulation table comprises: a body support section, the body support section comprising: at least one body plate having first and second surfaces and first and second ends; at least one body support member rotatably attached to at least one surface of the body plate; and at least one body pad releasably attached to at least one surface of the body plate; a head support section in operable communication with the body support section, the head support section comprising: at least one head plate having first and second surfaces and first and second ends; at least one head support member rotatably attached to at least one surface of the head plate; and at least one head pad releasably attached to at least one surface of the head plate. The device can be configured to go from an expanded configuration to a collapsed configuration to allow for transport and storage.

### FIELD OF INVENTION

The present invention relates to portable spinal manipulation or adjusting tables and methods for using same.

### BACKGROUND OF THE INVENTION

Traditional chiropractic tables are generally bulky and take several minutes to set up and break down. While traditional tables may have some form of a folding mechanism, their large size prevent true transportability, such as carrying onto an airplane. Moreover, traditional chiropractic table, do not allow for execution of new techniques focused on the upper cervical/thoracic vertebrae.

Accordingly, there remains a need for new chiropractic methods and portable chiropractic tables which are capable of easily being moved from one location to another and capable of positioning the patient to enable a practitioner to perform adjustments and or spinal manipulations that would otherwise not be possible without a standard table. This need and other needs are satisfied by the various aspects of the present disclosure.

### SUMMARY OF THE INVENTION

In accordance with the purposes of the invention, as embodied and broadly described herein, the invention, in one aspect, relates to portable chiropractic tables and devices. The portable chiropractic device comprises a body support section, the body support section comprising: at least one body plate having first and second surfaces and first and second ends; at least one body support member rotatably attached to at least one surface of the body plate; and at least one body pad releasably attached to at least one surface of the body plate; a head support section in operable communication with the body support section, the head support section comprising: at least one head plate having first and second surfaces and first and second ends; at least one head support member rotatably attached to at least one surface of the head plate; and at least one head pad releasably attached to at least one surface of the head plate. The device can be configured to go from an expanded configuration to a collapsed configuration to allow for transport and storage.

In further aspects, the invention also relates to methods for using the disclosed devices and tables.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention.

FIG. 1 shows a depiction of a portable spinal manipulation device in accordance with an exemplary embodiment of the present invention.

FIG. 2 shows a depiction of a portable spinal manipulation device in accordance with an exemplary embodiment of the present invention.

FIG. 3 shows a depiction of a portable spinal manipulation device in accordance with an exemplary embodiment of the present invention.

FIG. 4 shows a depiction of a portable spinal manipulation device in accordance with an exemplary embodiment of the present invention.

FIG. 5 shows a depiction of a portable spinal manipulation device in accordance with an exemplary embodiment of the present invention.

FIG. 6 shows a depiction of a portable spinal manipulation device in accordance with another exemplary embodiment of the present invention.

FIGS. 7A-7C show depictions of various body pads for use with a portable spinal manipulation device in accordance with another exemplary embodiment of the present invention.

FIGS. 8A-8B show depictions of a pregnancy body pad for use with a portable spinal manipulation device in accordance with another exemplary embodiment of the present invention.

FIGS. 9A-9D shows depictions of a portable spinal manipulation device in accordance with another exemplary embodiment of the present invention.

FIGS. 10A-10B shows depictions of head pad adjustment of a portable spinal manipulation device in accordance with another exemplary embodiment of the present invention.

FIGS. 11A-11D shows depictions of head support section height and angle adjustment of a portable spinal manipulation device in accordance with another exemplary embodiment of the present invention.

FIGS. 12A-12D shows depictions of folding and collapsing a portable spinal manipulation device in accordance with another exemplary embodiment of the present invention.

### DETAILED DESCRIPTION OF THE INVENTION

The present invention can be understood more readily by reference to the following detailed description of the invention and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a head pad” includes two or more head pads.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed devices and articles of the invention as well as the materials themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the invention. Thus, if there are a variety of additional steps that can be performed it is understood that each of these additional steps can be performed with any specific aspect or combination of aspects of the methods of the invention.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. Portable Manipulation Table and Device

As briefly described above, the present disclosure relates, in various aspects, to portable devices and tables for providing chiropractic adjustments, spinal manipulations, or other treatments, such as massage, or the like. In further aspects, the device can comprise a version of a chiropractic table that is able to be used on any stable flat surface such as a table or the floor allowing the engaged surface to be used by a practitioner to perform chiropractic adjustments and or spinal manipulations that would otherwise not be possible without a standard table. In still further aspects, the portable table can have customized head pads that allow for better execution of original techniques for adjusting and/or manipulating lower cervical/ upper thoracic vertebrae that may be “rotated, stuck, or out of alignment”. In yet further aspects, the portable table can be folded in order to take up less space and allow for easier transportability. In even further aspects, the disclosed tables can be much lighter than the average portable chiropractic table and can fit in overhead luggage compartments according to most flight specifications. In yet further aspects, the disclosed portable table can set up and broken down in a few seconds versus the average table, which can be very bulky and can take several minutes to set up and break down.

In one aspect, the present disclosure provides a portable spinal manipulation device comprises a body support section, the body support section comprising: at least one body plate having first and second surfaces and first and second ends; at least one body support member rotatably attached to at least one surface of the body plate; and at least one body pad releasably attached to at least one surface of the body plate; a head support section in operable communication with the body support section, the head support section comprising: at least one head plate having first and second surfaces and first and second ends; at least one head support member rotatably attached to at least one surface of the head plate; and at least one head pad releasably attached to at least one surface of the head plate. The device can be configured to go from an expanded configuration to a collapsed configuration to allow for transport and storage.

In a further aspect, the device can comprise a plurality of body support plates or a plurality of body pads. In still further aspects, the body pad can be disposed longitudinally on the first surface of the body plate. In yet further aspects, the body pads can comprise an upper surface that defines a first horizontal plane when the body pad is disposed in a substantially flat neutral position.

In further aspects, the device can comprise a plurality of body support members. In still further aspects, the body support member can be rotatably attached to the first or second surface of the body support plate. In yet further aspects, the body support member can be rotatably attached to the opposite surface than the body pad.

In further aspects, the body support member can be configured to rotate from a folded or collapsed position to an opened or expanded position. In still further aspects, the device in the collapsed or folded configuration can comprise dimensions within or compliant with domestic or international airline travel carry-on luggage regulations. Thus, in other aspects, the device in the collapsed or folded configuration comprises dimensions that would allow storage in an airplane overhead compartment. In further aspects, the body support member can collapse via a hinge and can have an auto locking mechanism that locks when the table is an opened or expanded configuration to improve stability.

In further aspects, the folded position can be configured to allow the head support section to a position adjacent to the second surface of the body plate. In yet further aspects, the expanded position is configured to raise a front portion or first end of the body support section above the horizontal. In even further aspects, the height cab be sufficient so as to allow the patient to rest their arms off the table in an abducted/externally rotated position of the shoulder in order to allow the scapulae to naturally rest away from the midline of the spine. In some aspects, the body support plate can be raised from greater than 0 to at least about 6 inches off the ground. In other aspects, the body support plate can be raised up to forty-five degrees (45°) above the horizontal, for example, the horizontal plate of the floor.

In further aspects, the body support plate can have a substantially planar shape or contoured shape, or a combination thereof. In some aspects, the contoured shape can be configured to ergonomically fit the spine and allow for improved accessibility to the thoracic spine in order to allow for optimal treatment techniques. In other aspects, the contoured shape can comprise a substantially flat portion towards the length of the thoracic spine and a curve down at a graded slope for the lumbar spine to comfortably allow the patient's body to rest on the floor. In further aspects, the body plate can be padded and seamlessly engages floor at an end of the body plate opposite to an end where the head support section is connected.

In further aspects, the body support member can be configured to allow for various degrees of elevation. In still further aspects, the body support member can be configured to allow for various height levels. In even further aspects, the body support member can comprise a plurality of positioning levels corresponding to different heights. In yet further aspects, the bottom portion of the base plate is configured to engage the floor. In some aspects, the opposite portion of the base plate is configured to engage the floor along with the body support member in order to create an incline.

In further aspects, the head plate can be rotatably connected to at least a portion of the body support section. In still further aspects, the head plate can be rotatably attached to at least a portion of the body support section. In yet further aspects, the head plate can be rotatably attached to at least a portion of the body support member. In even further aspects, the head plate can be rotatably attached to at least a portion of the body plate.

In further aspects, the device can comprise a plurality of head pads. In still further aspects, the head pad can be disposed on the first surface of the head plate. In yet further aspects, the head pad can be disposed on a head plate surface opposite to the surface of the head plate that is connected to the body support section.

In some aspects, the head plate can be rotatably attached to a first portion of the body support member, and the body plate can be rotatably attached to a different portion of the body support member. In other aspects, the head plate can be rotatably attached to a first surface of the body support member, and the body plate can be rotatably attached to a different surface of the body support member. In yet other aspects, the device can comprise body plate attachment positions on the body support member and head plate attachment positions on the body support member that can be configured to allow the device to from an expanded configuration to a collapsed or folded configuration for transport and storage.

In further aspects, the device can comprise a plurality of head support members. In still further aspects, the head support member can be rotatably attached to the second surface of the head plate. In yet further aspects, the head support member can be rotatably attached to the opposite surface than the head pad. In some aspects, head support member can be configured to transition from a folded or collapsed position to an opened or expanded position. In other aspects, when in the folded position, the head support member can be releasably secured to a portion of the body plate. In yet other aspects, when in the folded position, the head support member can be releasably secured to the same surface of the body plate as the body support member.

In further aspects, the head support plate can be positioned up to forty-five degrees (45°) above or below the horizontal plane of the body plate. In still further aspects, the head support member can be configured to allow for various degrees of incline and/or decline. In even further aspects, the head support member can be configured to allow for various height levels. In still further aspects, the head support member can be configured to allow for various angles. In yet further aspects, the head support member can be configured to allow for various height levels.

In further aspects, a bottom portion of the head support member is configured to engage the floor or ground when in the expanded configuration. In some aspects, the head support member can comprise a plurality of positioning levels corresponding to different heights. In other aspects, the head support member can be configured to allow for varying degrees of flexion, extension, or a neutral spine.

In further aspects, the head pads can define an opening or groove, which is configured to engage a periphery of a user's head when lying prone on the body support section. In still further aspects, the head pad can comprise a tubular or semi-tubular shape. In yet further aspects, the head pad can comprise an internal compartment configured for storing and dispensing a rolled paper product.

In various aspects, the head pad position can be adjusted. In further aspects, the head pads can comprise a parallel orientation. In still further aspects, the head pads can be configured to be adjusted toward or away from each other to adjust a size of the opening between head pads. In yet further aspects, the head pads can be attached using a track system or Velcro, or a combination thereof. In even further aspects, the head pads can be configured to be adjusted to varying widths to accommodate different treatment techniques. In some aspects, the head pads are interchangeable. In other aspects, the head pads can comprise a density effective to allow improved execution of an inventive technique that enables increased likelihood of adjusting lower cervical/upper thoracic segments of the spine. In further aspects, the inventive technique comprises an improved version of a cervico/thoracic rotational manipulation. It is executed by applying pressure with the elbow alongside the spinous process of the lower verterbrae of the intended joint to be adjusted and thrusting in a direction towards the opposite armpit or pelvis while rotating and sidebending the head in a thrusting motion with your free hand towards the ipsilateral side that enables increased likelihood of adjusting lower cervical/upper thoracic segments of the spine.

In further aspects, the head pad opening can further comprise a center bar. In still further aspects, the center bar can be configured to allow dispensed paper product to be held in place. In yet further aspect, the device can further comprise a paper cutter for cutting the dispensed paper product.

In further aspects, the device can comprise an auto-locking mechanism for maintaining the device in the expanded or opened configuration. In still further aspects, the device can comprise a button or other release mechanism configured to release the device from the folded configuration or opened configuration. In some aspects, the device can further comprise non-slip material disposed on at least one surface of at least one device component configured to engage the floor.

In further aspects, the body support plate can comprise a securing means for releasably securing the head support section to the body support plate. In still further aspects, the body pad and head pad can be comprised of an impact-reducing or resilient material, or a combination thereof.

In further aspects, the device components can comprise a plurality of securing or connecting means, such as, and without limitation, Velcro at one portion and a clamping mechanism on another portion of the device component. In still further aspects, the device components can be connected using a connecting means. In yet further aspects, the connecting means can comprise a hinge or similar connecting mechanism. In still further aspects, the device components can be releasably coupled using a coupling means. In yet further aspects, the coupling means can comprise friction fitting, snap ring, O-ring, pressure fitting, clip, clasp, and the like. In some aspects, the coupling means can be configured to hold a device component in place until a user moves the device component to a different position.

In various aspects, the securing means comprises a clip, clamp, latch, bracket, snap, fitting, clasp, Velcro, strap, tie wraps, hook and latch, loop and tie, cable, elastic, band, button and buttonholes, or combinations thereof. In further aspects, the connecting means comprises a hinge or similar connecting mechanism. In further aspects, the components can be releasably connected. In a still further aspect, the connection can be achieved using a snap, friction fitting, snap ring, O-ring, pressure fitting, clip, clasp, and the like. The snap ring or O-ring can be retained within a groove to accommodate the snap ring or O-ring. In a further aspect, the device can comprise an engagement means for coupling and holding components together. In a further aspect, the engagement means can be a screwing mechanism, a click-lock mechanism, or friction mechanism, or the like. In other aspects, the connecting means can comprise a fitting, insert, adhesive, brazing, soldering, welding, spot weld, screw with nut, or rivet, or a combination thereof.

Without wishing to be bound by a particular theory, the combination of inventive attachment configurations, and/or securement devices allow the portable chiropractic table and device to be used for better execution of treatment techniques, and in almost any patient setting.

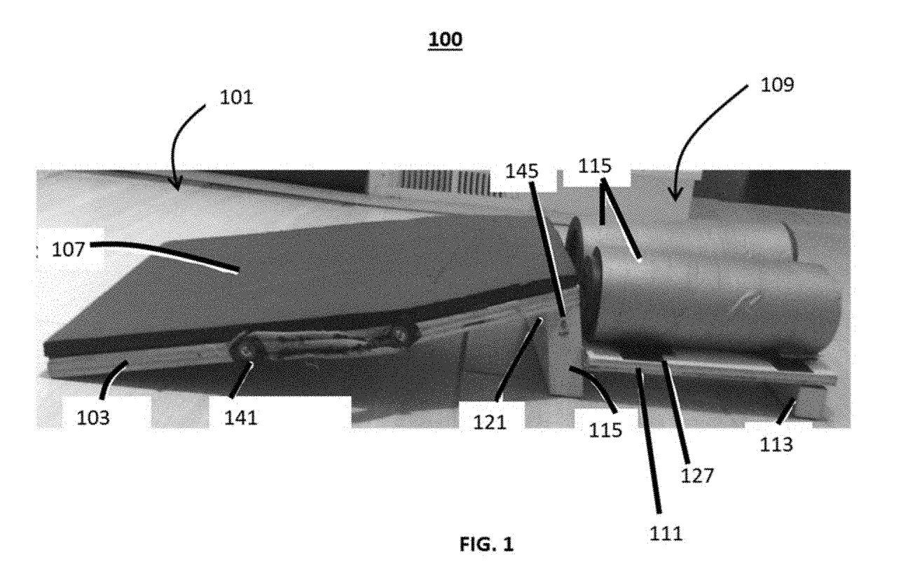

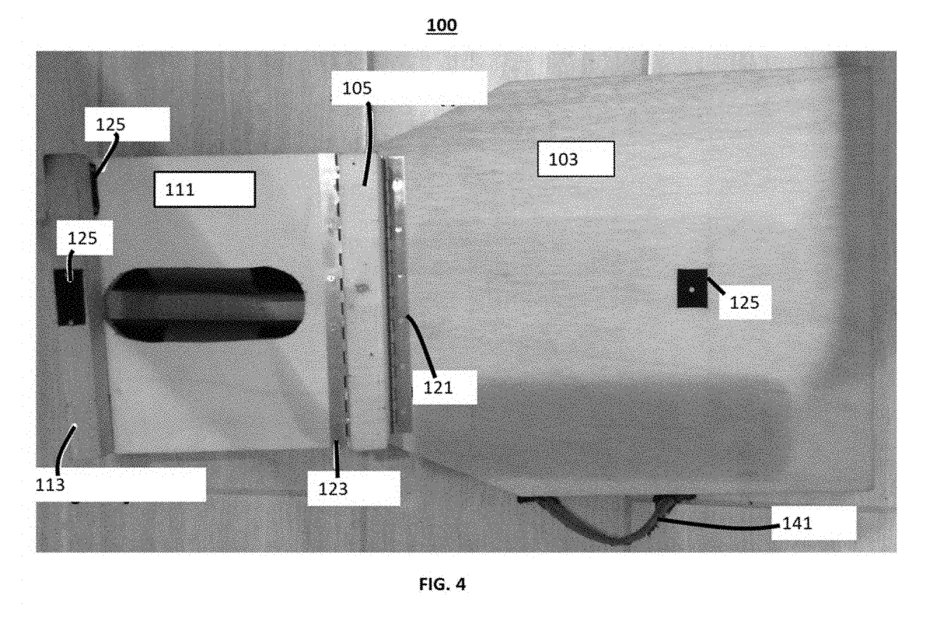

According to various aspects of the invention, the portable chiropractic devices and tables can comprise multiple configurations. For example, various exemplary embodiments of the inventive portable spinal manipulation devices and tables are shown in FIGS. 1-12D.

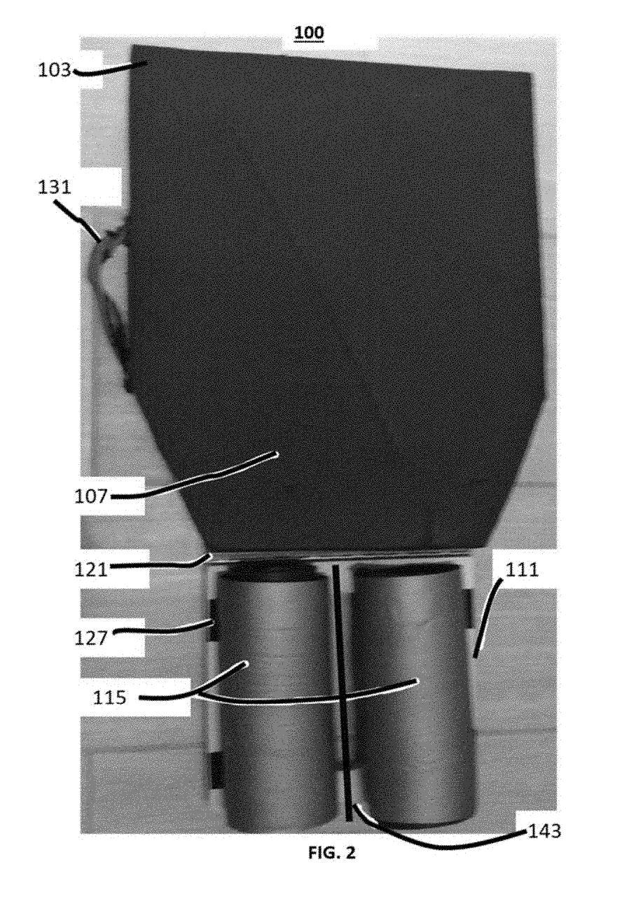

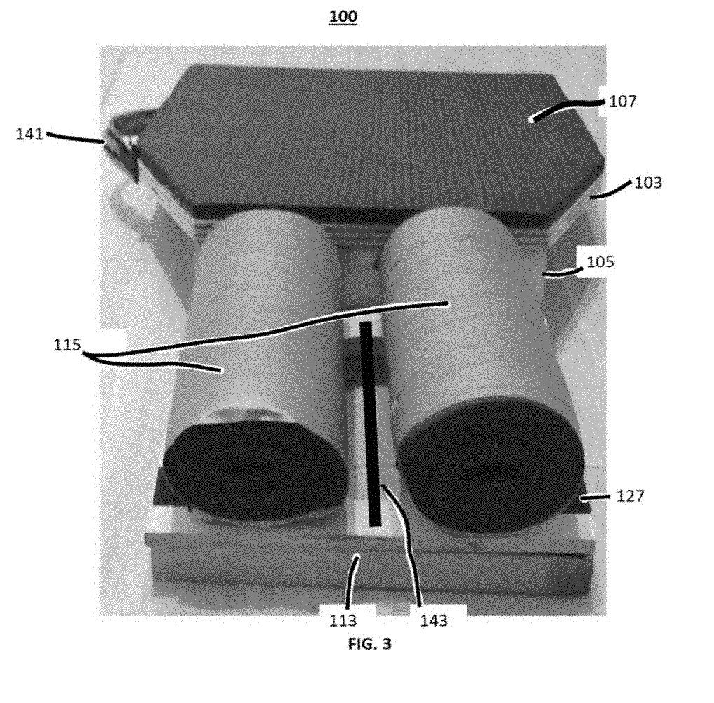

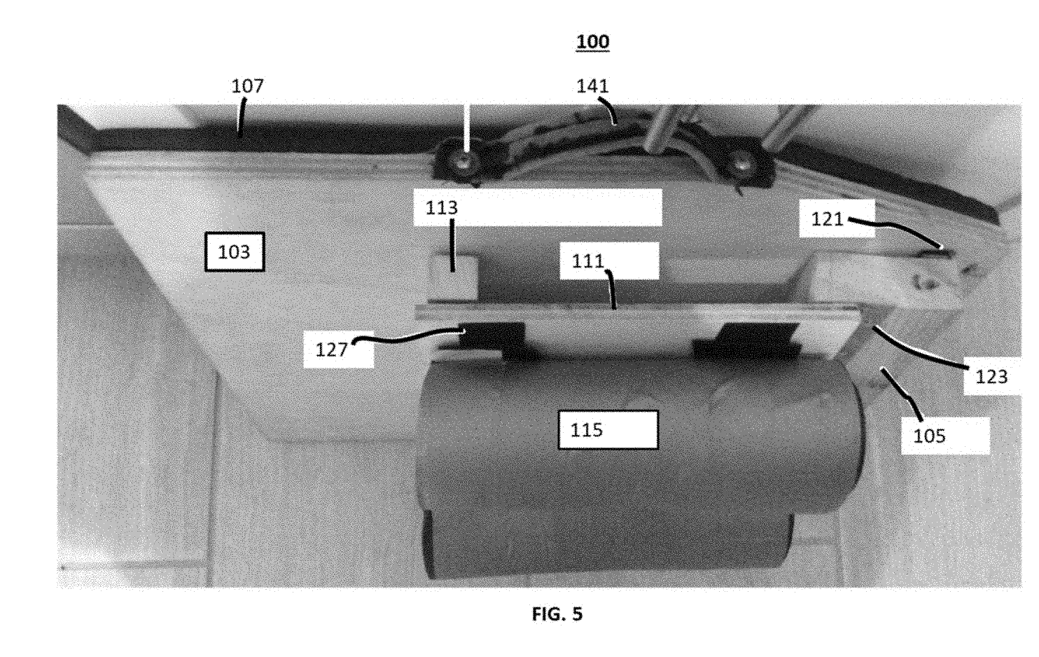

As shown in FIGS. 1-5, the portable spinal manipulation device 100 comprises: a body support section 101, the body support section comprising a body plate 103 having first and second surfaces and first and second ends, a body support member 105 rotatably attached to a bottom surface of the body plate 103 using a body attachment means 121 in the form of a hinge, and a body pad 107 releasably attached to the top surface of the body plate; a head support section 109 in operable communication with the body support section 101, the head support section 109 comprising a head plate 111 having first and second surfaces and first and second ends and rotatably attached to a surface of the body support member 105 using a head plate attachment means 123 in the form of a hinge, a head support member 113 rotatably attached to a bottom surface of the head plate 111 using a head support member attachment means 125, and a pair of head pads releasably attached to a top surface of the head plate 111 using a head pad attachment means 127 in the form of hook and loop fastener (e.g., Velcro). The device 100 may also comprise a handle 141 and is configured to go from an opened or expanded configuration (FIGS. 1-4) to a collapsed or folded configuration (FIG. 5) to allow for easy transport and storage. As shown in FIGS. 2-3, the device 100 may further comprise a center bar 143 configured to hold and dispense a roll paper product.

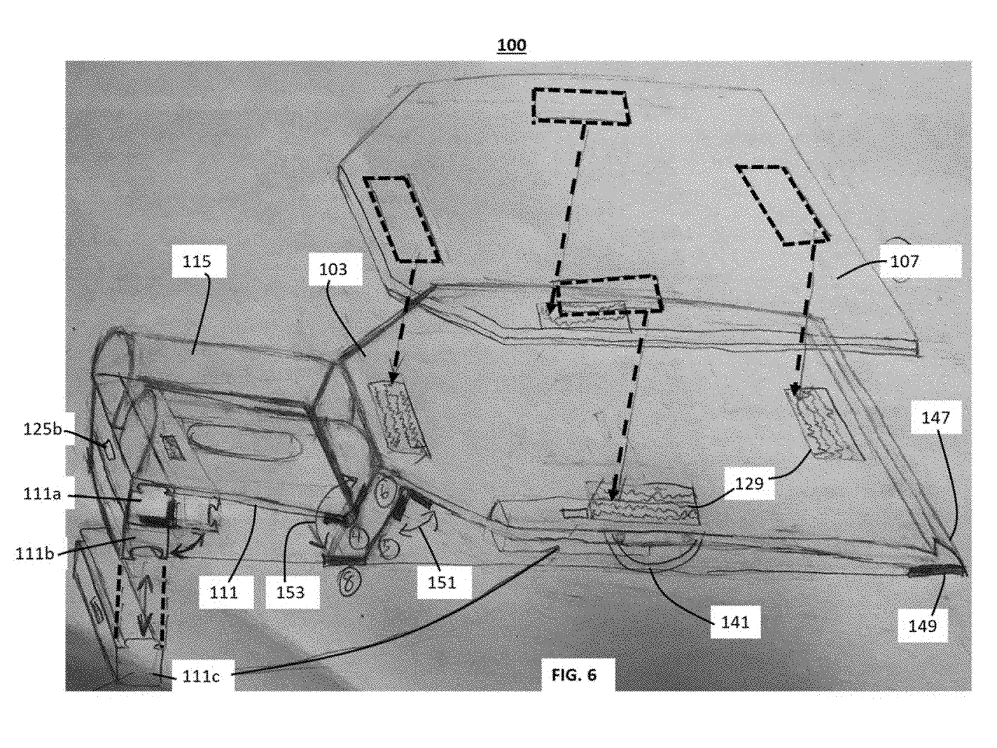

As shown in FIGS. 6-8B, the disclosed devices can be configured to have replaceable body pads adapted for a specific patient types and sizes. FIG. 6 shows another depiction of device 100, where body pad 107 is shown detached from body plate 103. Body pad 107 and body plate 103 have a plurality of corresponding attachment means 129 for detachably coupling the two parts together. Further, this embodiment further comprises a reducer component 147 affixed to the end of body plate 103 and a gripping portion 149 for keeping the device in place when engaged with a surface. The reducer component 147 has a lip that corresponds to a thickness of the body pad 107 such that when installed, the body pad 107 and reducer component 147 are equal height and form a smooth surface. Still further, this embodiment comprises a height adjustment mechanism for adjusting the height of the head support section from a surface, such as the floor. Here, the device 100 comprises a second head support member 111b releasably attached to a first head support member 111a, wherein the second head support member is attached via an attachment means to allow the second head support member to pivotably rotate from a first position disposed on the bottom of the head plate to a second position disposed on a bottom surface of the first head support member to thereby increase the height of the head plate from an engaged surface, such as the ground. Still further, the device comprises a third head support member 111c configured to releasably attach to a bottom surface of the first or second head support members to thereby further increase the height of the head plate from an engaged surface, such as the ground, in order to increase the relative angle 153 of the headboard to allow extension of the neck. The angle 153 can be adjusted from about 15 degrees to about 120 degrees.

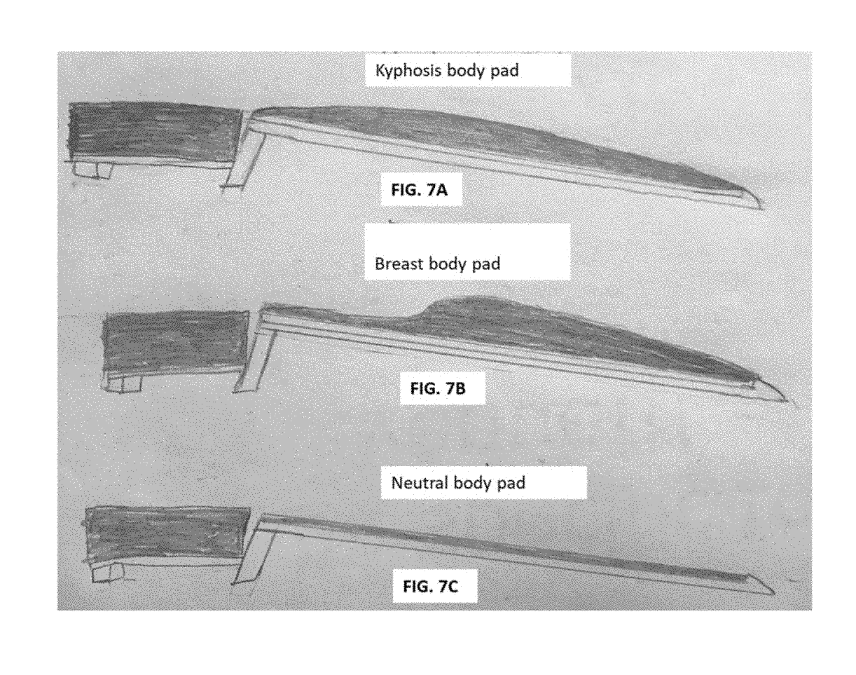

As shown in FIGS. 7A-7C, the replaceable body pad can comprise a kyphosis pad adapted to increase flexion in an upper thoracic region on a spine, a neutral pad adapted for a neutral spine position or technique, or a breast pad adapted to increase the height on the stomach region, thereby leaving a breast region adapted to provide relative relief for breasts from pressing against the body pad. In the breast body pad, the stomach region may be at least twice the height of the breast region, such as where the stomach region height to the breast region height is from about 2:1 to about 5:1.

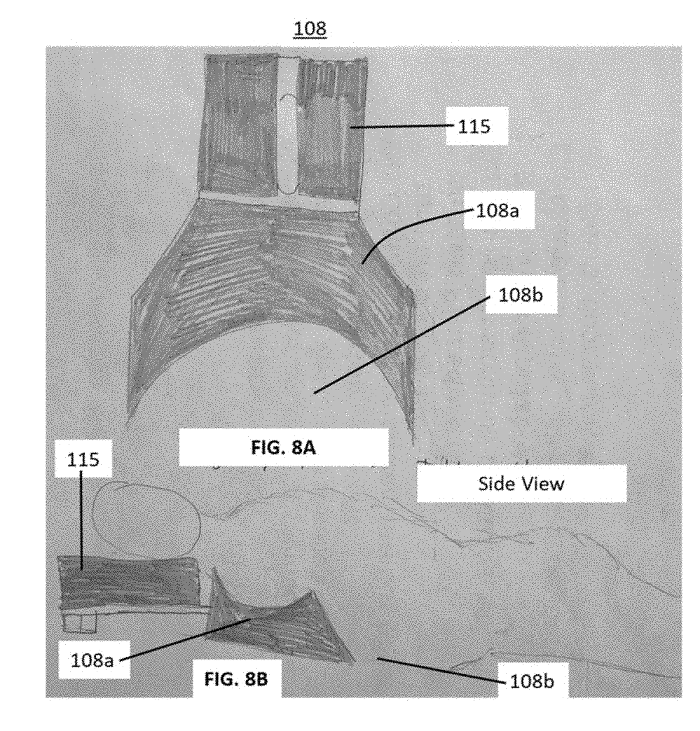

As shown in FIGS. 8A-8B, the body pad may comprise a pregnancy pad 108. The pregnancy pad 108 is adapted to provide relief to a stomach area 108b from pressing against an engaged surface when laying on the device. The pregnancy pad 108 is adapted to increase the height on the chest region 108a, thereby leaving a stomach region 108b adapted to provide relative relief for the stomach from pressing against the body pad. Here, the chest region is at least twice the height of the stomach region, such as where the chest region height to the stomach region height is from about 2:1 to about 20:1.

The gripping portion can comprise comprise a rubber base or similar material configured to increase the amount of friction with the portion of the object engaged and to protect the surface of the object engaged and is generally disposed on a bottom of the body plate at the lowest point of the body plate.

The the body plate 103 when used with reducer component 147 is configured to be disposed flush to a surface, such as a floor, thereby allowing alternate body pads to be releasably attached to the body plate using an attachment means, such as, for example Velcro.

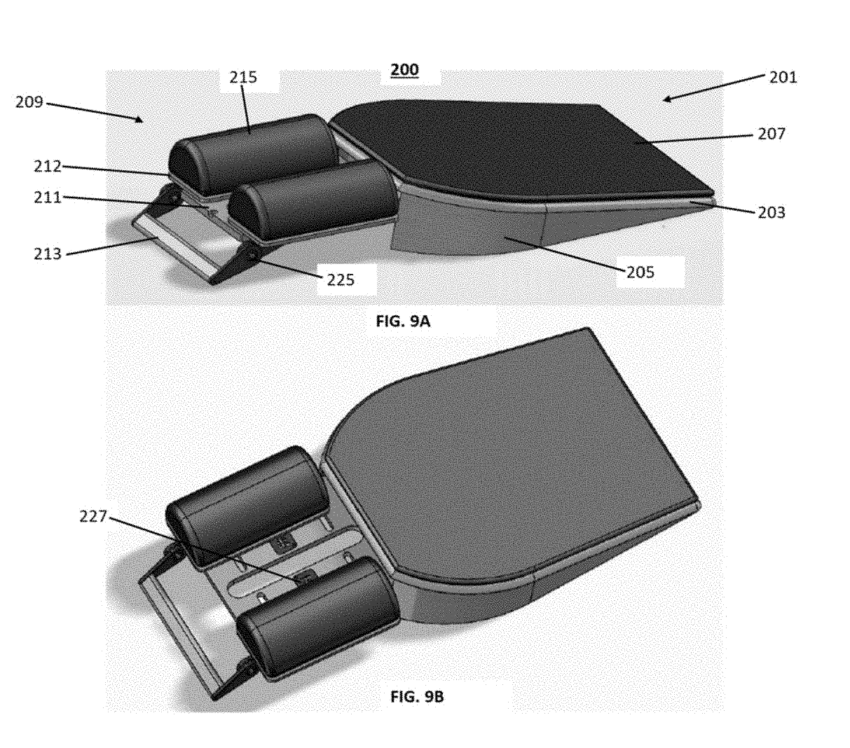

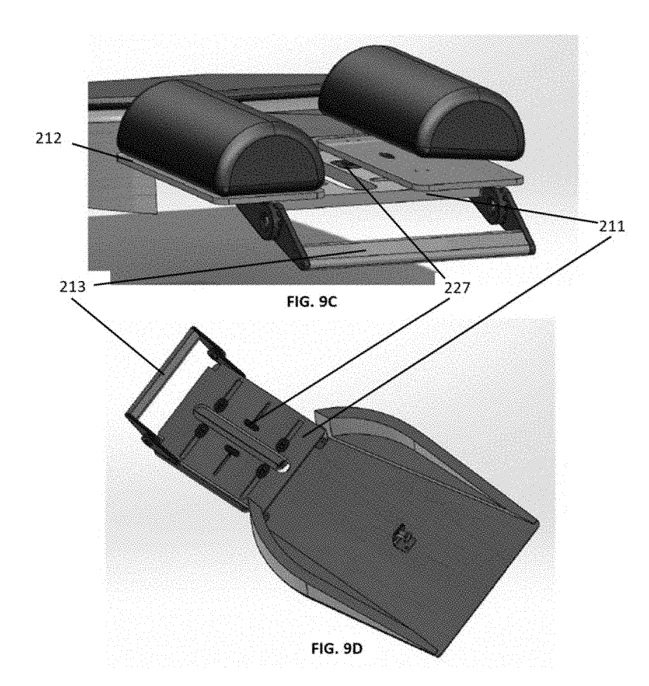

FIGS. 9A-12D show various views and components of another spinal manipulation device 200 in accordance with an exemplary embodiment of the present invention. Here the portable spinal manipulation device 200 comprises: a body support section 201, the body support section comprising a body plate 203 having first and second surfaces and first and second ends, a body support member 205 attached to a bottom surface of the body plate 203, and a body pad 207 releasably attached to the top surface of the body plate; a head support section 209 in operable communication with the body support section 201, the head support section 209 comprising a head plate 211 having first and second surfaces and first and second ends and rotatably attached to a surface of the body support member 205 using a head plate attachment means 223 in the form of a hinge, a head support member 213 rotatably attached to a bottom surface of the head plate 211 using a head support member attachment means 225, and a pair of head pads on mounting plate 212 releasably attached to a top surface of the head plate 211 using a head pad attachment means 227. Head support member 213 can be used as a handle to support and carry device.

As shown in FIGS. 10A-B, head pad attachment means 227 comprises a head pad sliding mechanism including stop element 228a and lock plate 228b configured to allow the head pads to slide together and/or apart, where the sliding mechanism comprises a click-lock mechanism configured to lock in a plurality of locking positions along a track. The device can further comprise pegs 229, configured to hold the headrest onto the head plate. The stop element fits into lock plate to lock head pad in place. As shown, a user can push down on “T” to unlock and slide side to side, and release to snap back into notch.

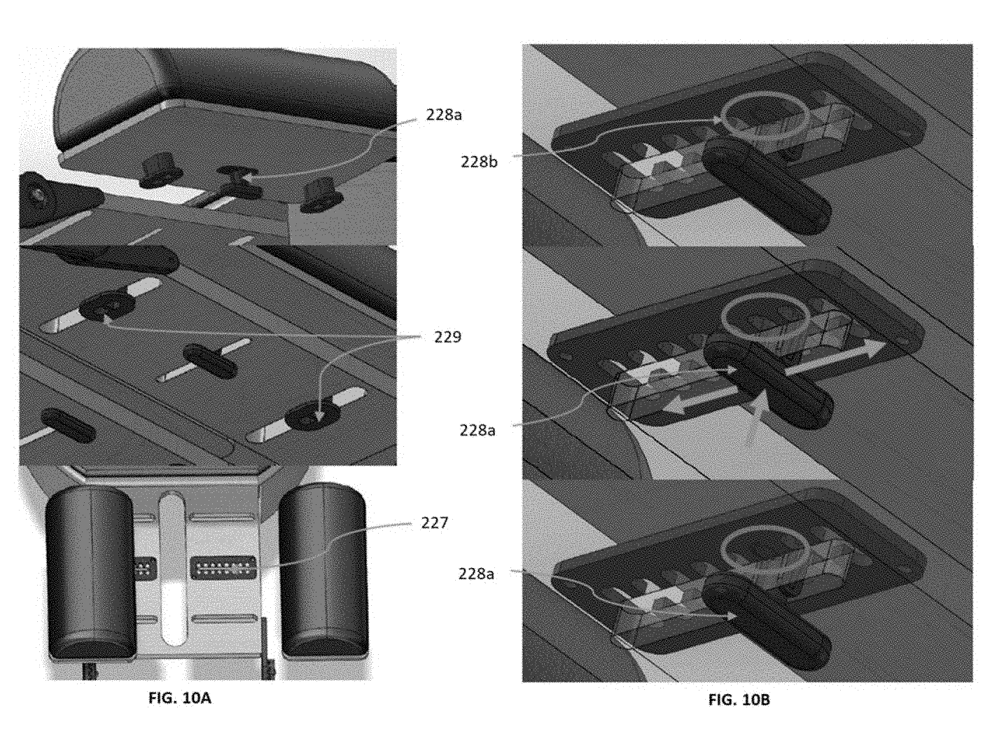

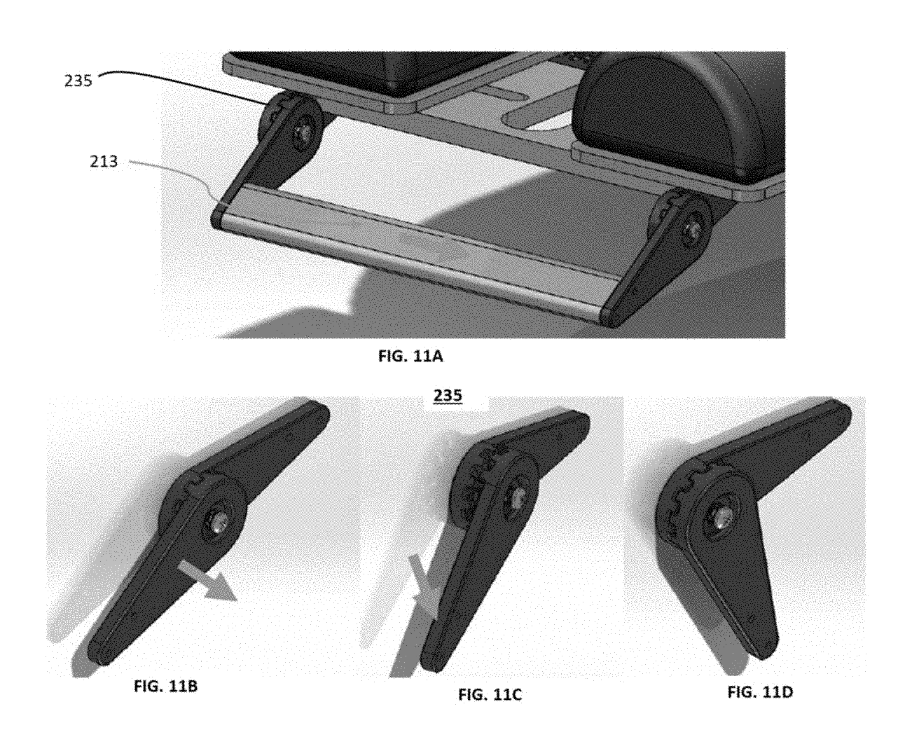

As shown in FIGS. 11A-D, the device may further comprise a height adjustment mechanism for adjusting the height of the head support section. Here, head support member 213 can be used to adjust angle by pulling an end out of attachment means 235, rotating around, and releasing to lock into place.

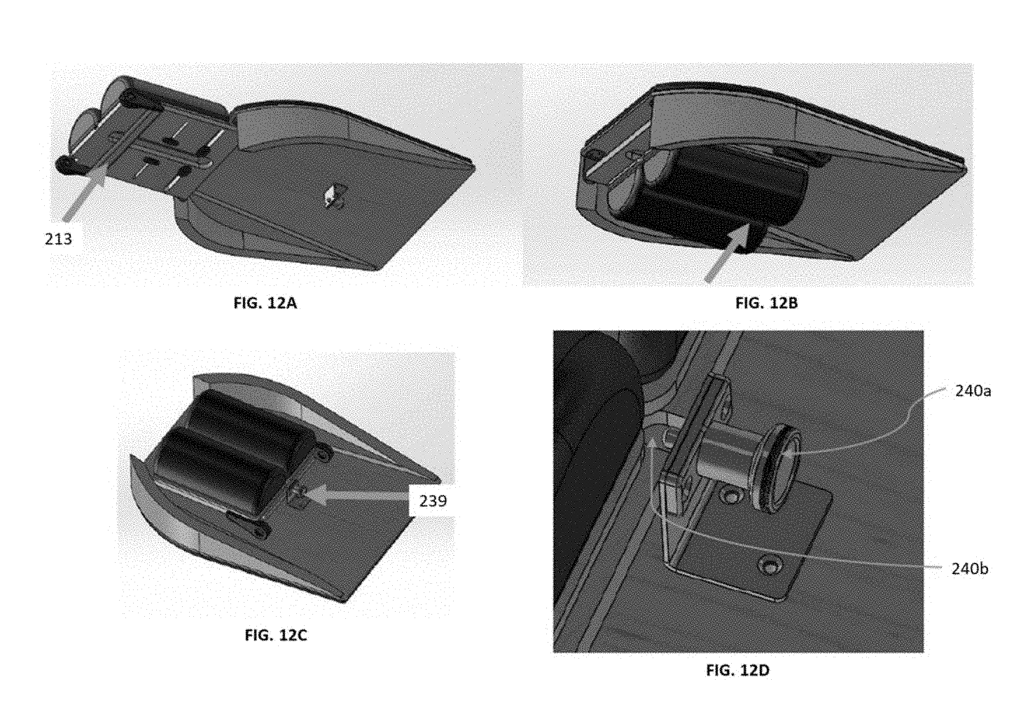

As shown in FIGS. 12A-12D, device 200 can be folded from an expanded configuration into a collapsed configuration. As shown, the device may comprise a locking mechanism 239 configured to maintain the device is an expanded position or configuration, and/or a collapsed position or configuration. The locking mechanism 239 may be configured to release the device from an expanded position or configuration to a collapsed position or configuration, or vice versa. For example, a notch 240b disposed on the head plate may be configured to allow the head support section to be releasably attached to the body support section in the collapsed position or configuration by receiving peg of pull out knob 240b of locking mechanism 239. In further aspects, the locking mechanism can comprise any releasable attachment means for keeping the device secured in a collapsed position or configuration, such as a magnet, Velcro, or the like.

The present invention includes at least the following aspects: Aspect 1: A portable spinal manipulation device, the device comprising: a) a body support section, the body support section comprising at least one body plate having first and second surfaces and first and second ends; at least one body support member rotatably attached to at least one surface of the body plate; and at least one body pad releasably attached to at least one surface of the body plate; b) a head support section in operable communication with the body support section, the head support section comprising: at least one head plate having first and second surfaces and first and second ends, and rotatably attached to at least one surface of the body support member; at least one head support member rotatably attached to at least one surface of the head plate; and at least one head pad releasably attached to at least one surface of the head plate; wherein the device is configured to go from an opened or expanded configuration to a collapsed or folded configuration to allow for transport and storage.

Aspect 2: The device of any preceding aspect, wherein the body pad is disposed longitudinally on the first surface of the body plate and has an upper surface that defines a first horizontal plane when the body pad is disposed in a substantially flat neutral position.

Aspect 3: The device of any preceding aspect, wherein the device comprises a plurality of body support members.

Aspect 4: The device of any preceding aspect, wherein the body support member is rotatably attached to the second surface of the body plate.

Aspect 5: The device of any preceding aspect, wherein the body support member is rotatably attached to the opposite surface than the body pad.

Aspect 6: The device of any preceding aspect, wherein the body support member is configured to rotate from a folded position to an expanded position.

Aspect 7: The device of any preceding aspect, wherein the folded position is configured to allow the head support section to a position adjacent to the second surface of the body plate.

Aspect 8: The device of any preceding aspect, wherein the expanded position is configured to raise a front portion of the body support section above the horizontal.

Aspect 9: The device of any preceding aspect, wherein the height is sufficient so as to allow the patient to rest their arms off the table in an abducted/externally rotated position of the shoulder in order to allow the scapulae to naturally rest away from the midline of the spine.

Aspect 10: The device of any preceding aspect, wherein body support member can collapse via a hinge and will have an auto locking mechanism that locks when the table is an opened or expanded configuration to improve stability.

Aspect 11: The device of any preceding aspect, wherein the body support plate can be raised from greater than 0 to at least about 6 inches off the ground.

Aspect 12: The device of any preceding aspect, wherein the body support plate can be raised from greater than 0 to at least about 12 inches off the ground.

Aspect 13: The device of any preceding aspect, wherein the body support plate can be raised up to forty-five degrees (45°) above the horizontal.

Aspect 14: The device of any preceding aspect, wherein the body support plate can be at 180 degrees (180°) relative to the horizontal.

Aspect 15: The device of any preceding aspect, wherein the body support plate has a substantially planar shape or contoured shape, or a combination thereof.

Aspect 16: The device of any preceding aspect, wherein the contoured shape is configured to ergonomically fit the spine and allow for improved accessibility to the thoracic spine in order to allow for optimal treatment techniques.

Aspect 17: The device of any preceding aspect, wherein the contoured shape comprises a substantially flat portion towards the length of the thoracic spine and a curve down at a graded slope for the lumbar spine to comfortably allow the patient's body to rest on the floor.

Aspect 18: The device of any preceding aspect, wherein the body plate is padded and seamlessly engages floor at an end of the body plate opposite to an end where the head support section is connected.

Aspect 19: The device of any preceding aspect, wherein the device in the collapsed or folded configuration comprises dimensions within domestic or international airline travel carry-on luggage regulations.

Aspect 20: The device of any preceding aspect, wherein the device in the collapsed or folded configuration comprises dimensions that would allow storage in an airplane overhead compartment.

Aspect 21: The device of any preceding aspect, wherein the body support member is configured to allow for various degrees of elevation.

Aspect 22: The device of any preceding aspect, wherein the body support member is configured to allow for various height levels.

Aspect 23: The device of any preceding aspect, wherein when elevated, a bottom portion of the base plate is configured to engage the floor or a surface.

Aspect 24: The device of any preceding aspect, wherein the body support member comprises a plurality of positioning levels corresponding to different heights.

Aspect 25: The device of any preceding aspect, wherein the head plate is rotatably connected to at least a portion of the body support section.

Aspect 26: The device of any preceding aspect, wherein the head plate is rotatably attached to at least a portion of the body support section.

Aspect 27: The device of any preceding aspect, wherein the head plate is rotatably attached to at least a portion of the body support member.

Aspect 28: The device of any preceding aspect, wherein the head plate is rotatably attached to at least a portion of the body plate.

Aspect 29: The device of any preceding aspect, wherein the head pad is disposed longitudinally on the first surface of the head plate.

Aspect 30: The device of any preceding aspect, wherein the head pad is disposed on a head plate surface opposite to the surface of the head plate that is connected to the body support section.

Aspect 31: The device of any preceding aspect, wherein the head plate is rotatably attached to a first portion of the body support member, and the body plate is rotatably attached to a different portion of the body support member.

Aspect 32: The device of any preceding aspect, wherein the head plate is rotatably attached to a first surface of the body support member, and the body plate is rotatably attached to a different surface of the body support member.

Aspect 33: The device of any preceding aspect, wherein a body plate attachment position on the body support member and a head plate attachment position on the body support member are configured to allow the device to from an expanded configuration to a collapsed or folded configuration for transport and storage.

Aspect 34: The device of any preceding aspect, wherein the device comprises a plurality of head support members.

Aspect 35: The device of any preceding aspect, wherein the head support member is rotatably attached to the second surface of the head plate.

Aspect 36: The device of any preceding aspect, wherein the head support member is rotatably attached to the opposite surface than the head pad.

Aspect 37: The device of any preceding aspect, wherein the head support member is configured to transition from a folded position to an expanded position.

Aspect 38: The device of any preceding aspect, wherein in the folded position, the head support member is releasably secured to a portion of the body plate.

Aspect 39: The device of any preceding aspect, wherein in the folded position, the head support member is releasably secured to the same surface of the body plate as the body support member.

Aspect 40: The device of any preceding aspect, wherein the head support plate can be positioned to forty-five degrees (45°) above or below the horizontal plane of the body plate.

Aspect 41: The device of any preceding aspect, wherein the head support plate can be positioned to 180 degrees (180°) above or the horizontal plane of the body plate.

Aspect 42: The device of any preceding aspect, wherein the head support member is configured to allow for various degrees of incline and/or decline.

Aspect 43: The device of any preceding aspect, wherein the head support member is configured to allow for various height levels.

Aspect 44: The device of any preceding aspect, wherein the head support member is configured to allow for various angles.

Aspect 45: The device of any preceding aspect, wherein the head support member is configured to allow for various height levels.

Aspect 46: The device of any preceding aspect, wherein a bottom portion of the head support member is configured to engage the floor or ground when in the expanded configuration.

Aspect 47: The device of any preceding aspect, wherein the head support member comprises a plurality of positioning levels corresponding to different heights.

Aspect 48: The device of any preceding aspect, wherein the head support member is configured to allow for varying degrees of flexion, extension, or a neutral spine.

Aspect 49: The device of any preceding aspect, wherein the device comprises a plurality of head pads.

Aspect 50: The device of any preceding aspect, wherein the head pads defining an opening or groove, which is configured to engage a periphery of a user's head when lying prone on the body support section.

Aspect 51: The device of any preceding aspect, wherein the head pad comprises a tubular or semi-tubular shape.

Aspect 52: The device of any preceding aspect, wherein the head pad comprises an internal compartment configured for storing and dispensing a rolled paper product.

Aspect 53: The device of any preceding aspect, wherein the head pad position can be adjusted.

Aspect 54: The device of any preceding aspect, wherein the head pads can comprise a parallel orientation.

Aspect 55: The device of any preceding aspect, wherein the head pads are configured to be adjusted toward or away from each other to adjust a size of the opening between head pads.

Aspect 56: The device of any preceding aspect, wherein the head pads are attached using a track system or Velcro, or a combination thereof.

Aspect 57: The device of any preceding aspect, further comprising a height adjustment mechanism for adjusting the height of the head support section from a surface, such as the floor.

Aspect 58: The device of any preceding aspect, wherein the height adjustment mechanism may comprise an adjustable head support member configured to connect to at least one of another head support member or a head plate; or an adjustable body support member configured to connect to at least one of another body support member or a body plate.

Aspect 59: The device of any preceding aspect, wherein the height adjustment mechanism can be configured to connect using a notch and groove mechanism or via an attachment means (e.g., Velcro)

Aspect 60: The device of any preceding aspect, wherein the attachment means can comprises a mechanism adapted to attach and reattach the component.

Aspect 61: The device of any preceding aspect, wherein the height adjustment mechanism can be configured to provide from about a 10-degree to about 40-degree angle relative to the body board.

Aspect 62: The device of any preceding aspect, wherein the device comprises a second head support member releasably attached to a first head support member, wherein the second head support member is attached via a hinge configured to allow the second head support member to pivotably rotate from a first position disposed on the bottom of the head plate to a second position disposed on a bottom surface of the first head support member to thereby increase the height of the head plate from an engaged surface, such as the ground.

Aspect 63: The device of any preceding aspect, wherein the second position is configured to provide a neutral or 0-degree angle relative to the body plate.

Aspect 64: The device of any preceding aspect, further comprising an attachment means to allow securing of the support member to a bottom surface of the head plate and/or a bottom surface of another support member.

Aspect 65: The device of any preceding aspect, further comprising an additional head support member configured to releasably attach to a bottom surface of the first or second head support members to thereby increase the height of the head plate from an engaged surface, such as the ground, in order to increase the relative angle of the headboard to allow extension of the neck.

Aspect 66: The device of any preceding aspect, wherein at least one additional head support member is configured to be stored on a bottom surface of the body plate.

Aspect 67: The device of any preceding aspect, wherein at least one additional head support member is configured to be stored using the same or different attachment means, such as Velcro or magnet.

Aspect 68: The device of any preceding aspect, wherein the attachment means connecting the head support section to the body support section may comprise a vertical track to allow the head plate to slide up and down.

Aspect 69: The device of any preceding aspect, wherein the attachment means connecting the head plate to the body support member may comprise a vertical track to allow the head plate to slide up and down.

Aspect 70: The device of any preceding aspect, wherein the attachment means connecting the base plate to the head plate may be attached to a vertical track to allow the head plate to slide up and down.

Aspect 71: The device of any preceding aspect, wherein the base plate may be adjusted to provide an angle from about 15 degrees to about 180 degrees.

Aspect 72: The device of any preceding aspect, wherein the base support member is configured to provide an angle from about 15 degrees to about 90 degrees relative to the engaged surface (e.g., ground).

Aspect 73: The device of any preceding aspect, further comprising a locking mechanism configured to maintain the device is an expanded position or configuration.

Aspect 74: The device of any preceding aspect, wherein the locking mechanism is configured to release the device from an expanded position or configuration to a collapsed position or configuration.

Aspect 75: The device of any preceding aspect, further comprising an attachment means disposed on the front surface of the first head support member configured to allow the head support section to be releasably attached to the body support section in the collapsed position or configuration.

Aspect 76: The device of any preceding aspect, wherein the attachment means disposed on the front surface of the first head support member may comprise a pull knob, magnet, Velcro, or any other releasable attachment means for keeping the device secured in a collapsed position or configuration.

Aspect 77: The device of any preceding aspect, further comprising at least one gripping portion disposed on a portion of the device configured to engage the ground.

Aspect 78: The device of any preceding aspect, wherein the gripping portion comprises a rubber base or similar material configured to increase the amount of friction with the portion of the object engaged and to protect the surface of the object engaged.

Aspect 79: The device of any preceding aspect, wherein the gripping portion is disposed on a bottom of the body plate at the lowest point of the body plate.

Aspect 80: The device of any preceding aspect, wherein the body plate is configured to disposed flush to a surface, such as a floor, thereby allowing alternate body pads to be releasably attached to the body plate using an attachment mean, such as, for example Velcro.

Aspect 81: The device of any preceding aspect, wherein the body pad further comprises a thin mounting board with padding disposed on a top surface top, and an attachment means, e.g. Velcro, disposed on a bottom surface for releasably attaching the body pad onto the base plate.

Aspect 82: The device of any preceding aspect, wherein the body bod comprises a neutral pad adapted for a neutral spine position or technique.

Aspect 83: The device of any preceding aspect, wherein the body pad comprises a breast pad adapted to increase the height on the stomach region, thereby leaving a breast region adapted to provide relative relief for breasts from pressing against the body pad.

Aspect 84: The device of any preceding aspect, wherein the stomach region is at least twice the height of the breast region.

Aspect 85: The device of any preceding aspect, wherein the stomach region height to the breast region height is from about 2:1 to about 5:1.

Aspect 86: The device of any preceding aspect, wherein the body pad comprises a kyphosis pad adapted to increase flexion in an upper thoracic region on a spine.

Aspect 87: The device of any preceding aspect, wherein the body pad comprises a pregnancy pad.

Aspect 88: The device of any preceding aspect, wherein the pregnancy pad is adapted to provide relief to a stomach area from pressing against an engaged surface when laying on the device.

Aspect 89: The device of any preceding aspect, wherein the body pad comprises a pregnancy pad adapted to increase the height on the chest region, thereby leaving a stomach region adapted to provide relative relief for the stomach from pressing against the body pad.

Aspect 90: The device of any preceding aspect, wherein the chest region is at least twice the height of the stomach region.

Aspect 91: The device of any preceding aspect, wherein the chest region height to the stomach region height is from about 2:1 to about 20:1.

Aspect 92: The device of any preceding aspect, further comprising a head pad sliding mechanism configured to allow the head pads to slide together and/or apart.

Aspect 93: The device of any preceding aspect, wherein the sliding mechanism comprises a click-lock mechanism configured to lock in a plurality of locking positions along a track.

Aspect 94: The device of any preceding aspect, further comprising a compartment for storing and dispensing sanitizing wipes for the head pads at the bottom of the headboard.

Aspect 95: The device of any preceding aspect, wherein the compartment is located below the head support plate.

Aspect 96: The device of any preceding aspect, further comprising a paper roll dispenser integrated within at least one head pad

Aspect 97: The device of any preceding aspect, wherein the paper roll dispenser is configured to allow for paper to pulled over the head pads.

Aspect 98: The device of any preceding aspect, wherein the head pad opening further comprises a center bar.

Aspect 99: The device of any preceding aspect, wherein the center bar is configured to allow dispensed paper product to be held in place.

Aspect 100: The device of any preceding aspect, further comprising a paper cutter for cutting the dispensed paper product.

Aspect 101: The device of any preceding aspect, wherein the device further comprises an auto-locking mechanism for maintain the device in the expanded or opened configuration.

Aspect 102: The device of any preceding aspect, wherein the device further comprises non-slip material disposed on at least one surface of at least one device component configured to engage the floor.

Aspect 103: The device of any preceding aspect, wherein the device can comprise a button or other release mechanism configured to release the device from the folded configuration or opened configuration.

Aspect 104: The device of any preceding aspect, wherein the body support plate can comprise a securing means for releasably securing the head support section to the body support plate.

Aspect 105: The device of any preceding aspect, wherein the body pad and head pad are comprised of an impact-reducing or resilient material, or a combination thereof.

Aspect 106: The device of any preceding aspect, wherein the device components can comprise a plurality of securing or connecting means, such as, and without limitation, Velcro at one portion and a clamping mechanism on another portion of the device component.

Aspect 107: The device of any preceding aspect, wherein the device components are connected using a connecting means.

Aspect 108: The device of any preceding aspect, wherein the connecting means comprises a hinge or similar connecting mechanism.

Aspect 109: The device of any preceding aspect, wherein the securing means comprises a clip, clamp, latch, magnet, bracket, snap, fitting, clasp, Velcro, strap, tie wraps, hook and latch, loop and tie, cable, elastic, band, button and buttonholes, or combinations thereof.

Aspect 110: The device of any preceding aspect, wherein device components are releasably coupled using a coupling means.

Aspect 111: The device of any preceding aspect, wherein the coupling means comprise friction fitting, snap ring, O-ring, pressure fitting, clip, clasp, and the like.

Aspect 112: The device of any preceding aspect, wherein the coupling means is configured to hold a device component in place until a user moves the device component to a different position.

Aspect 113: The device of any preceding aspect, further comprising a handle for carrying or transporting the device.

Aspect 114: The device of any preceding aspect, wherein the handle is disposed on a side of the body support section.

Aspect 115: The device of any preceding aspect, wherein the head support member is configured as a handle for carrying or transporting the device.

Aspect 116: The device of any preceding aspect, further comprising a plurality of legs configured to maintain the device at predetermined height above a surface.

Aspect 117: The device of any preceding aspect, wherein the head pads are configured to be adjusted to varying widths to accommodate different treatment techniques.

Aspect 118: The device of any preceding aspect, wherein a space between the head pads can be made narrower so that the head is in a proper position superficially on the head pads so that it can be rotated easier off to the sides during a cervical/thoracic (C/T) junction and upper thoracic manipulation.

Aspect 119: The device of any preceding aspect, wherein the density of the head pads can be firmer so that the head can roll off the side without sinking into the head pads and loosing counter rotation of the head pad on the side of the face during a C/T junction and upper thoracic manipulation.

Aspect 120: The device of any preceding aspect, wherein a rounded contour of the top of the head pad is configured to allow the head to roll off the side of the pads more easily than a typical flat top head pad during a C/T junction and upper thoracic manipulation.

Aspect 121: The device of any preceding aspect, wherein the head pads are interchangeable.

Aspect 122: The device of any preceding aspect, wherein the head pads comprise density effective to allow improved execution of a technique as disclosed herein.

Aspect 123: The device of any preceding aspect, wherein the technique comprises an improved version of a cervical/thoracic rotational manipulation.

Aspect 124: The device of any preceding aspect, wherein the technique is executed by applying pressure with the elbow alongside the spinous process of the lower vertebrae of the intended joint to be adjusted and thrusting in a direction towards the opposite armpit or pelvis while rotating and side bending the head in a thrusting motion with your free hand towards the ipsilateral side that enables increased likelihood of adjusting lower cervical/upper thoracic segments of the spine.

Aspect 125: A method of treating a patient operative with the device or system of any preceding aspect as specified in the description.

Aspect 126: A method for treating a patient comprising using the device of any preceding aspect to administer a treatment.

Aspect 127: The method of any preceding aspect, wherein the treatment comprises at least one of: a chiropractic adjustments, spinal manipulations, acupuncture, massage, or stomach sleeping, or the like.

Aspect 128: A method of using the device as specified in the description and FIGURES.

Aspect 129: The method of any preceding aspect, as further specified by the FIGURES.

Aspect 130: A system operative to perform the method of any preceding aspect.

Aspect 131: A system as specified in the description and the FIGURES.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A portable spinal manipulation device, the device comprising:
a) a body support section, the body support section comprising
i) at least one body plate having first and second surfaces and first and second ends;
ii) at least one body support member rotatably attached to at least one surface of the body plate; and
iii) at least one body pad releasably attached to at least one surface of the body plate.
b) a head support section in operable communication with the body support section, the head support section comprising:
i) at least one head plate having first and second surfaces and first and second ends, and rotatably attached to at least one surface of the body support member;
ii) at least one head support member rotatably attached to at least one surface of the head plate; and
iii) at least one head pad releasably attached to at least one surface of the head plate;
wherein the device is configured to go from an opened or expanded configuration to a collapsed or folded configuration to allow for transport and storage.

2. The device of claim 1, wherein the body pad is disposed longitudinally on the first surface of the body plate and has an upper surface that defines a first horizontal plane when the body pad is disposed in a substantially flat neutral position.

3. The device of claim 2, wherein the body support member is rotatably attached to the second surface of the body plate.

4. The device of claim 3, wherein the body support member is rotatably attached to the opposite surface than the body pad.

5. The device of claim 4, wherein the body support member is configured to rotate from a folded position to an expanded position.

6. The device of claim 5, wherein the folded position is configured to allow the head support section to a position adjacent to the second surface of the body plate; and wherein the expanded position is configured to raise a front portion of the body support section above the first horizontal.

7.-22. (canceled)

23. The device of claim 6, wherein the body support member comprises a plurality of positioning levels corresponding to different heights.

24.-28. (canceled)

29. The device of claim 23, wherein the head pad is disposed on a head plate surface opposite to the surface of the head plate that is connected to the body support section.

30. (canceled)

31. The device of claim 29, wherein the head plate is rotatably attached to a first surface of the body support member, and the body plate is rotatably attached to a different surface of the body support member.

32. The device of claim 31, wherein a body plate attachment position on the body support member and a head plate attachment position on the body support member are configured to allow the device to go from an expanded configuration to a folded configuration for transport and storage.

33. (canceled)

34. (canceled)

35. (canceled)

36. (canceled)

37. (canceled)

38. The device of claim 32, wherein in the folded position, the head support member is releasably secured to the same surface of the body plate as the body support member.

39.-55. (canceled)

56. The device of claim 38, further comprising a height adjustment mechanism for adjusting the height of the head support section from a surface, such as the floor.

57. The device of claim 56, wherein the height adjustment mechanism comprises at least one of an adjustable head support member configured to connect to at least one of another head support member and a head plate; and an adjustable body support member configured to connect to at least one of another body support member and a body plate.

58. (canceled)

59. (canceled)

60. (canceled)

61. The device of claim 57, wherein the device comprises a second head support member releasably attached to a first head support member, wherein the second head support member is attached via a hinge configured to allow the second head support member to pivotably rotate from a first position disposed on the bottom of the head plate to a second position disposed on a bottom surface of the first head support member to thereby increase the height of the head plate from an engaged surface.

62. (canceled)

63. (canceled)

64. The device of claim 61, further comprising an additional head support member configured to releasably attach to a bottom surface of the first or second head support members to thereby increase the height of the head plate from an engaged surface in order to increase the relative angle of the headboard to allow extension of the neck.

65.-73. (canceled)

74. The device of claim 64, further comprising an attachment means disposed on the front surface of the first head support member configured to allow the head support section to be releasably attached to the body support section in a collapsed configuration.

75. (canceled) cm 76. (canceled)

77. (canceled)

78. (canceled)

79. (canceled)

80. (canceled)

81. (canceled)

82. The device of claim 74, wherein the body pad comprises a breast pad adapted to increase the height on a stomach region, thereby leaving a breast region adapted to provide relative relief for breasts from pressing against the body pad.

83. (canceled)

84. (canceled)

85. The device of claim 74, wherein the body pad comprises a kyphosis pad adapted to increase flexion in an upper thoracic region on a spine.

86. (canceled)

87. (canceled)

88. The device of claim 74, wherein the body pad comprises a pregnancy pad adapted to increase a height on the chest region, thereby leaving a stomach region adapted to provide relative relief for a stomach from pressing against the body pad.

89.-129. (canceled)
